(19) United States
(12) Patent Application Publication
(10) Pub. No.: US 2006/0101417 A1
(43) Pub. Date: May 11, 2006

(54) Automatic generation of device and user profiles

(76) Inventor: Simon T.H. Hoh, Selangor (MY)

Correspondence Address: NIXON & VANDERHYE, PC, 901 NORTH GLEBE ROAD, 11TH FLOOR, ARLINGTON, VA, 22203, US

(21) Appl. No.: 10/539,056

(22) PCT Filed: Dec. 2, 2003
(86) PCT No.: PCT/GB03/05277

§ 371 Date: Jun. 15, 2005

(30) Foreign Application Priority Data
Dec. 31, 2002 (GB) 0230329.5

(51) Int. Cl. G06F 9/44

(52) U.S. Cl. 717/130; 714/47

(57) ABSTRACT

A host server downloads a diagnostic program which is then used to interrogate a client device from time to time for its capabilities to generate a profile, which is used to generate a device entry in a database and to provide a reference address which is transmitted back to the client terminal. When the user wishes to access data from a website, he uses his terminal to transmit a data request, which includes a header carrying the address of the device profile on the database associated with the host. The target server (website), on receiving the data request, uses the address to interrogate the data base to retrieve the profile to be sent back to the website, which can then use the retrieved client device profile to select the content and form of the data to be sent to the user terminal.

This invention relates to the process of tailoring content and presentation of data access systems such as “Internet” websites to the needs of individual particular users and access devices (“browsers”), a process which will be referred to herein as “personalisation”. This allows web-site content to be personalised to suit the browser characteristics.

There are two ways of personalising a web-site. The first way is to create different versions of the same content, store the different versions on the website and use the personalisation characteristics to decide which version of the content to send to the client, as described by Benkiran, A. and Ajhoun, R. “Towards An Adaptative And Cooperative Tele-Learning” Proceedings of the International Conference on Engineering Education, Session 7B1, pp 22-27, 2001. The second way is to dynamically alter the content retrieved by the web-server before it is displayed, as described by Lakshmi Viiappu, Ah-Hwee Tan, and Chew-Lim Tan. “Web Structure Analysis for Information Mining” Proceedings of the ICDAR'01 Workshop on Web Document Analysis, Seattle, 2001. In both cases the transformation is usually achieved using the extensible mark up language (XML) and the associated Stylesheet language (XSL).

There is an extension of WAP (Wireless Application Protocol) 1.1 that enables a User Agent Profile (UAProf), also referred to as Capability and Preference Information (CPI), to be transferred from a WAP client to a server, as reported in Wireless Application Protocol Forum, Ltd. “WAG UAProf”, Version 20-October-2001. This extension seeks to interoperate seamlessly with the emerging standards for CC/PP distribution over the Internet. The specification defines a set of components and attributes that WAP-enabled devices may convey within the CPI. This CPI may include, but is not limited to, hardware characteristics (screen size, color capabilities, image capabilities, manufacturer), software characteristics (operating system vendor and version, support for MExE, list of audio and video encoders), application/user preferences (browser manufacturer and version, markup languages and versions supported, scripting languages supported), WAP characteristics (WML script libraries, WAP version, WML deck size), and network characteristics such as, latency and reliability.

The literature mainly details static device profiles for personalisation. In one proposal, reported by Korolev, V. and Joshi, A. “An End-End Approach to Wireless Web Access” In Proceedings of the 21^{st} IEEE International Conference, Distributed Computing Systems Workshops, pp 473-478, IEEE Computer Society, April, 2001, the client passes its characteristics to the server via a single static URI (Uniform Resource Identifiers) relating to the generalised type device, such as ‘PDA’, ‘Laptop’, ‘Desktop PC’ and ‘WAP Phone’. Another system, discussed by Seshan, S., Stemm, M. and Katz, R. H. “SPAND: Shared Passive Network Performance Discovery” In Proc 1st Usenix Symposium on Internet Technologies and Systems (USITS '97) Monterey, Calif., December, 1997, considers the device's network performance in personalising content.

Devices like the mobile phone have their governing specification (UAPROF) developed by the WAP Forum which requires the mobile maker to provide this profile for every model on the internet. Thus when a WAP (Wireless Application Protocol) mobile device accesses the internet, the capabilities of the device can be accessed. However, these are fixed profiles, as only one profile is stored for all devices of the same model. Customisable devices are being developed in which the capabilities can be altered to suit different consumer needs. Other computers such as PCs and portable computers (laptops) communicate with the internet through modems and do not have any dynamic method to provide information to other devices, with which they may require to communicate, of what their capabilities are. A process of tailoring the profile more closely to the requirements of the user, as well as the characteristics of the device being used, is required.

It is known, for example from International Patent Specification WO99/57657 (Lextrori) for pre-stored user information relating to different types of user terminal to be used to configure the host/client interface. However, this system only allows terminal-specific information to be used. Details of any special configuration of the device applied by the user, or of his personal preferences, or the context in which it is currently working, are not catered for by this system.

According to the invention there is provided hosting apparatus for generating and storing profile information relating to client devices, comprising means for interrogating a client device, means for generating a client device profile based on the results of said interrogation, storage means for storing client device profiles so generated, means for generating reference codes identifying the stored client device profiles and transmitting said reference codes to the respective client devices, the storage means being arranged to retrieve the profile of a client device on receipt, from a data accession device, of a data request including the reference code relating to that client device, wherein the interrogation means comprises means for transmitting a diagnostic program to the client device, and means for activating the diagnostic program and analysing inputs received from the client device to generate the client device profile.

The apparatus also preferably comprises means for causing a client device to transmit the said reference code as part of data requests made to data accession devices.

The invention also extends to a data access terminal having means for generating a client device profile, comprising diagnosis means for determining properties of the terminal and/or of its user, means for generating a client device profile derived from the said properties, means for transmitting the client device profile to a store associated with a host server, means for receiving from the host server an address from which the client device profile can be retrieved, and means for making a data request to a database in which the said address is transmitted with the data request to allow the database to retrieve the client device profile from the store, the diagnosis means comprising a diagnostic program loaded onto the terminal, and means for activating the diagnostic program to generate a client device profile and means for transmitting the client device profile to a host server.

According to another aspect, the invention provides a method of generating profile information relating to client devices, comprising the steps of interrogating the client for its capabilities, generating a profile, storing the profile in a database, and generating a reference code for transmission to the client to allow retrieval of the relevant profile, comprising the step of transmitting a diagnostic program to the client device, activating the diagnostic program at predetermined times, and generating the client device profile from the results of said diagnosis.

The interrogation and subsequent steps can be repeated from time to time to allow for changes in context. Preferably the method comprises the step of retrieving the profile information from the database in response to a data request incorporating the reference code. The method may also comprise a step of causing a client device to transmit the said reference code as part of data requests made to data accession devices.

The invention also extends to a process for generating a client device profile for a data access terminal, wherein a diagnostic program is loaded onto the terminal and activated so as to perform a diagnosis process to determine properties of itself and/or of its user, generates a client device profile derived from the said properties, the terminal transmits the client device profile to a store associated with a host server, and receives from the host server an address from which the client device profile can be retrieved, and when the data access terminal makes a data request to a database, the said address is transmitted with the data request to allow the database to retrieve the client device profile from the store, wherein the terminal performs a self-diagnosis process to determine properties of itself and/or of its user, and generates a client device profile derived from the said properties,

The diagnosis process may be performed autonomously, or under the control of the host device.

The invention extends to a computer program product or suite of computer program products for use with one or more computers to carry out the method of the invention or to provide any of the apparatus according to the invention.

The computer program product may be embodied on any suitable carrier readable by a suitable computer input device, such as CD-ROM, optically readable marks, magnetic media, punched card or tape, or on an electromagnetic or optical signal.

This invention provides a method for dynamically hosting and serving device profiles to web-server to enable the personalisation of the web-content to the current context in which the device finds itself. The data stored may relate to the nature of the device and the current context in which the device finds itself, and may also relate to user-preferences for further content personalisation.

User profiles relating to individual client devices can therefore be hosted publicly, in essence providing a persistent resource on the internet for any server to access as required.

An embodiment of the invention will now be described, by way of example, with reference to the drawings in which

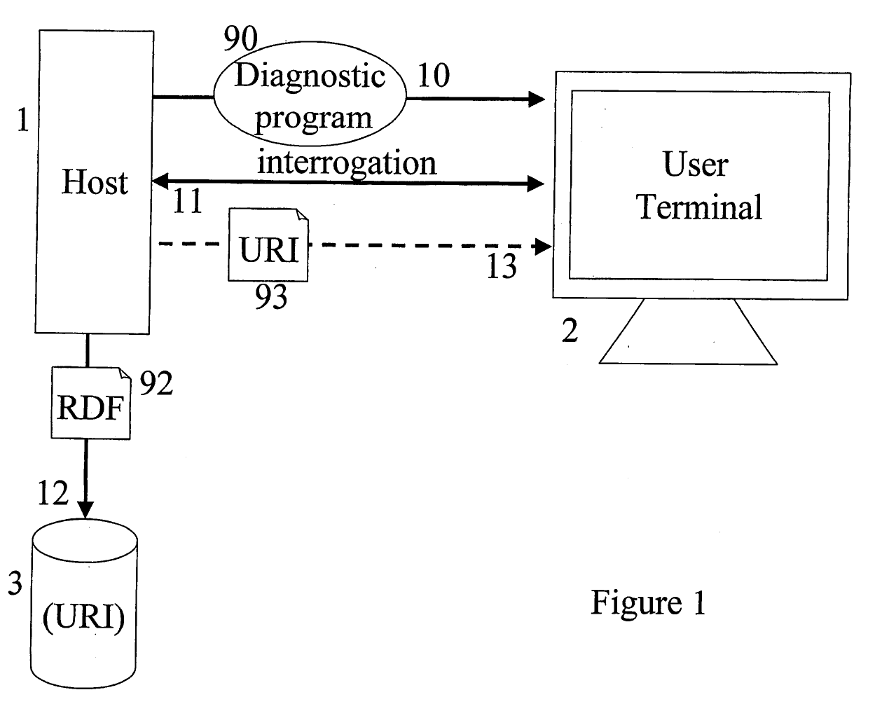

FIG. 1 illustrates a hosting device according to the invention, and the various devices which co-operate with it in performance of the method of generating a client device profile;

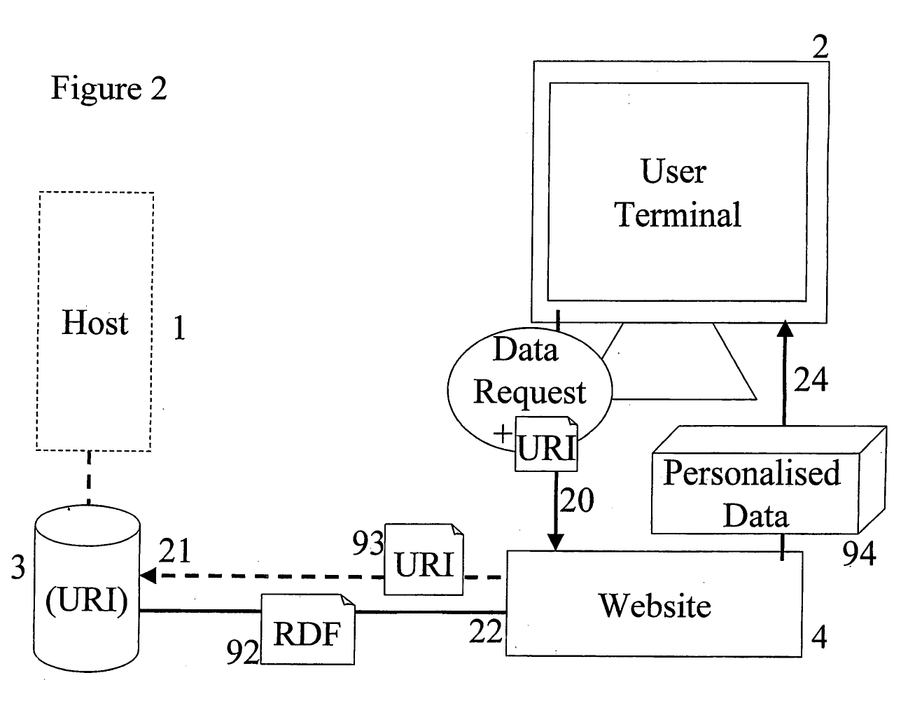

FIG. 2 illustrates the process of retrieving the client device profile.

FIG. 1 shows a host server 1 according to the invention, serving a large number of client user terminals, one of which is shown at 2. Associated with the host terminal 2 is a terminal profile store 3. Also shown is a website 4. The website 4 is one of many accessible by the user terminal over the interriet, by using an access request 20 addressed to the universal resource locator (“url”) appropriate to that website.

When a user 1 requests data from the website 4, the website 4 is arranged to return data according to a specified client device profile. In prior art arrangements this can be achieved by the user transmitting those details with the request. Such arrangements are, for instance used in the WAP standard, in which the make and model of device making the request is identified. Some individual websites generate “cookies” which store user data at the user terminal. When subsequent access requests are made to the same website the data can be retrieved so that the website can recognise the user. However, cookies are specific to the website that generated them.

The Composite Capability/Preferences Profile (CC/PP) standard describes a method for using the Resource Description Format (RDF) of the W3C, to create a general, yet extensible framework for describing user preferences and device capabilities: see Klyne, G., Reynolds, F., Woodrow, C. and Ohto, H. “Composite Capability/Preference Profiles (CC/PP): Structure and Vocabularies”, World Wide Web Consortium (W3C) Working Draft 15 Mar. 2001. This information can be provided by the user to individual servers and content providers. The servers can use this information describing the user's preferences to customise the service or content provided.

For device personalisation to occur the characteristics of the device and browser need to be gathered and then transferred across the network to the server. In the present embodiment, the host server 1 downloads a diagnostic program 90 which is then used to interrogate the client 2 from time to time for its capabilities (step 11). The diagnostic program 90 may be stored on the terminal 2, or downloaded each time as shown (step 10). The hosting server 1 corresponds with the user terminal 2 using the diagnostic program to generate a profile 92, which in this embodiment uses the Resource Description Format (RDF) already discussed. This profile 92 is used to generate a device entry in a database 3 (step 12) and to provide a reference address in the form of a Uniform Resource Identifier (URI) 93 which is transmitted back to the client terminal 2 (step 13). This reference URI will be used in the header information of the client request 20 to point to its device profile 92 in the store 3.

Referring now to FIG. 2, when a user wishes to access data from a website 4, he uses his terminal 2 to transmit a data request 20. This data request 20 includes the standard Uniform Resource Location (url) which identifies the target website 4, and a header indicating the address of the terminal 2 to which the data requested is to be returned. In this embodiment the data request 20 also includes a header carrying the address (URI) 93 indicating the location of the device profile 92 to be the database 3 associated with the host 1. The target server (website) 4, on receiving the data request 20, uses the address 93 to interrogate the data base 3 (step 21). The address (URI) 93 identifies the exact profile (RDF) 92 to be sent back to the requester 4 (step 22). The requesting server 4 can then use the retrieved client device profile 92 to select the content and form of the data 94 to be sent to the user terminal 2 (step 24).

The ability to reference profile information (RDFs) via Uniform Resource Identifiers (URIs) assists in minimising the number of network transactions required to adapt content to a device as well as reducing the header length. Further, the CC/PP framework fits well into the current and future protocols being developed at the W3C and the WAP Forum. The periodic interrogation of the user terminal 2 by the host 1 allows changes in user preferences or equipment to be accommodated without any pro-active action by any server 4, other than the host server 1. Thus a user will always find that any website 4 that he wishes to access will pwersonalise the data according to his current preferences, as recorded on his terminal, and according to the capabilities of his current user terminal.

As will be understood by those skilled in the art, any or all of the software used to implement the invention can be contained on various transmission and/or storage mediums such as a floppy disc, CD-ROM, or magnetic tape so that the program can be loaded onto one or more general purpose computers or could be downloaded over a computer network using a suitable transmission medium.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. Hosting apparatus for generating and storing profile information relating to client devices, comprising means for interrogating a client device, means for generating a client device profile based on the results of said interrogation, storage means for storing client device profiles so generated, means for generating reference codes identifying the stored client device profiles and transmitting said reference codes to the respective client devices, the storage means being arranged to retrieve the profile of a client device on receipt, from a data accession device, of a data request including the reference code relating to that client device, wherein the interrogation means comprises means for transmitting a diagnostic program to the client device, and means for activating the diagnostic program and analysing inputs received from the client device to generate the client device profile.

2. Apparatus according to claim 1, comprising means for causing a client device to transmit the said reference code as part of data requests made to data accession devices.

3. A data access terminal having means for generating a client device profile, comprising diagnosis means for determining properties of the terminal and/or of its user, means for generating a client device profile derived from the said properties, means for transmitting the client device profile to a store associated with a host server, means for receiving from the host server an address from which the client device profile can be retrieved, and means for making a data request to a database in which the said address is transmitted with the data request to allow the database to retrieve the client device profile from the store, the diagnosis means comprising a diagnostic program loaded onto the terminal, and means for activating the diagnostic program to generate a client device profile and means for transmitting the client device profile to a host server.

4. A method of generating profile information relating to client devices, comprising the steps of interrogating the client for its capabilities, generating a profile, storing the profile in a database, and generating a reference code for transmission to the client to allow retrieval of the relevant profile, comprising the step of transmitting a diagnostic program to the client device, activating the diagnostic program at predetermined times, and generating the client device profile from the results of said diagnosis.

5. A method according to claim 6, comprising the step of retrieving the profile information from the database in response to a data request incorporating the reference code.

6. A method according to claim 4, comprising the step of causing a client device to transmit the said reference code as part of data requests made to data accession devices.

7. A process for generating a client device profile for a data access terminal, wherein a diagnostic program is loaded onto the terminal and activated so as to perform a diagnosis process to determine properties of itself and/or of its user, generates a client device profile derived from the said properties, the terminal transmits the client device profile to a store associated with a host server, and receives from the host server an address from which the client device profile can be retrieved, and when the data access terminal makes a data request to a database, the said address is transmitted with the data request to allow the database to retrieve the client device profile from the store,

8. A computer program product or suite of computer program products for use with one or more computers to carry out the method as set out claim 4.
